(19) United States
(12) Patent Application Publication
(10) Pub. No.: US 2012/0329903 A1
(43) Pub. Date: Dec. 27, 2012

(54) ACID-MODIFIED URETHANE PHENOXY ACRYLATE RESIN, AND METHOD FOR PREPARING SAME

(76) Inventor: Dae Yeun Kim, Jecheon-Si (KR)

(21) Appl. No.: 13/583,155

(22) PCT Filed: Feb. 22, 2011
(86) PCT No.: PCT/KR2011/001144

§ 371 Date: Sep. 6, 2012

(30) Foreign Application Priority Data
Mar. 11, 2010 (KR) 10-2010-0021745

(51) Int. Cl. C08G 8/32; C08L 61/14

(52) U.S. Cl. 522/178; 525/534

(57) ABSTRACT

The present invention relates to an acid modified urethane phenoxy acrylate resin and a method for preparing the same. More particularly, the present invention relates to an acid modified urethane phenoxy acrylate resin in which a urethane modified acrylic group is introduced at the side chain by reacting a phenol-novolac resin with (metha)acryloyloxyalkyl isocyanate or Bis(metha)acryloyloxyalkyl isocyanate and then reacting with an acid anhydride. According to the invention, it is provided a photosensitive resin having an excellent balance by maintaining heat resistance, adhesion, chemical resistance, electric resistance and the like which are shown from a resin used in a conventional photosensitive composition and improving flexibility, toughness, extensibility and the like.

### TECHNICAL FIELD

The present invention relates to an acid modified urethane phenoxy acrylate resin having a urethane modified acrylic moiety and an acid introduced at side chain and a method for preparing the same

### BACKGROUND

In response to demands for electric-electronic elements with the high density integration and thin package technique, a photosensitive composition, which is used for manufacturing such elements, is also required to have high performance. In accordance with such demands in electric-electronic industries, various photosensitive resins have been developed to improve conventional properties of heat resistance, toughness, plasticity, water resistance, adhesion, chemical resistance and the like.

A conventional photosensitive resin made from novolac type epoxy resin as a starting material has been widely used in the field of electronic materials since it has excellent adhesion, heat resistance, chemical resistance, electric resistance and the like. However, it shrinks significantly during a curing process, has poor expansibility, has lack of toughness and easily causes cracks due to thermal shock.

Photosensitive resins and their compositions prepared by using a bisphenol type epoxy resin or a cresol novolac type epoxy resin, which are developed to overcome the above-mentioned drawbacks, do not satisfy both heat resistance and toughness.

### SUMMARY

An object of the present invention is to provide a photosensitive resin having excellent balanced properties by not deteriorating heat resistance, adhesion, chemical resistance, electric resistance and the like which are shown in the conventional ones but improving flexibility, toughness, extensibility and the like, and a photosensitive composition using the same.

According to an aspect of the invention, there is provided an acid modified urethane phenoxy acrylate resin of Formula 1.

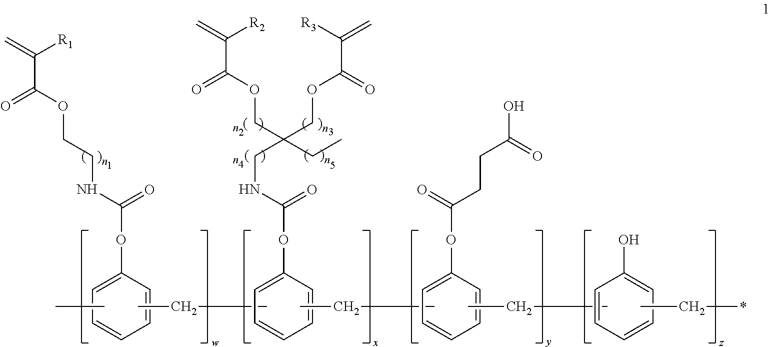

wherein, w, x is 0-0.7 mole, y is 0.1-0.5 mole, z is 0-0.7 mole,

R₁, R₂, R₃ each is CH₃ or H, and n₁, n₂, n₃, n₄, n₅ each is an integer of 0-2.

According to another aspect of the invention, there is provided a method for preparing an acid modified urethane phenoxy acrylate resin of Formula 1, in which the method comprises (a) obtaining a compound of Formula 4 by reacting a phenol-novolac resin of Formula 2 with at least one (metha)acryloyloxyalkyl isocyanate chosen from a compound of Formula 3 and Formula 3-1; and (b) reacting the compound of Formula 4 with an acid anhydride,

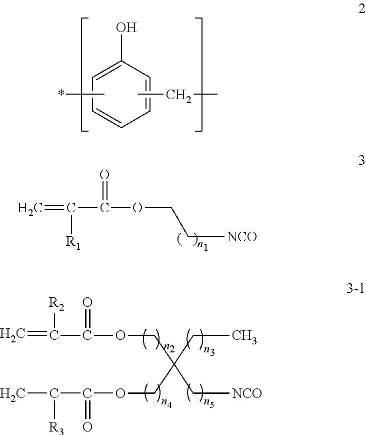

in Formula 3 and Formula 3-1, R₁, R₂, R₃ each is CH₃ or H, and n₁, n₂, n₃, n₄, n₅ each is an integer of 0-2.

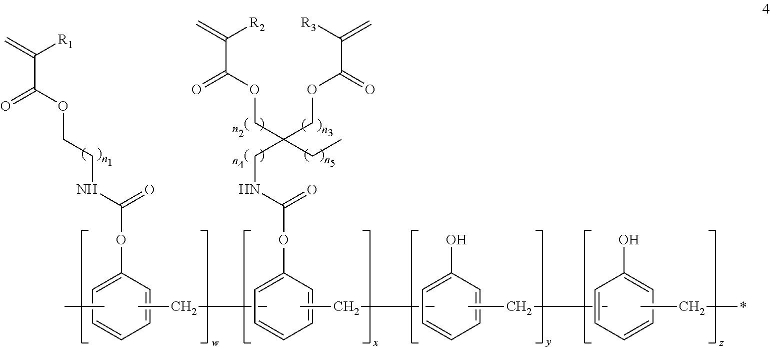

wherein, w, x is 0-0.7 mole, y+z is 0.3-0.8 mole.

According to an embodiment of the invention, the acid anhydride is a succinic anhydride of Formula 5.

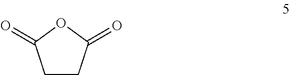

According to an embodiment of the invention, the step (a) is performed by using a reaction catalyst chosen from di-n-butyltin dilaurate, tri-n-butyltin acetate, triethylamine, n-tributyltin trichloride, trimethyltin hydroxide, 1,8-diazabicyclo[5.4.0]undec-7-ene (DBU) and 1,5-diazabicyclo[4.3.0]non-5-ene (DBN).

According to an embodiment of the invention, the step (b) is performed by using a reaction catalyst chosen from triphenylphospine, trimethylamine, triethylamine, benzyldimethylamine, dimethylaminomethyl phenol, tris(dimethylaminomethyl)phenol, methyltriethylammonium chloride, chromium octanoate and zirconium octanoate.

According to another aspect of the invention, there is provided a photosensitive resin composition comprising an acid modified urethane phenoxy acrylate resin of Formula 1, a photopolymerization initiator and a diluent.

According to the invention, there is provided a photosensitive resin with an excellent balance by maintaining properties of heat resistance, adhesion, chemical resistance, electric resistance and the like and by improving flexibility, toughness, extensibility and the like.

### DETAILED DESCRIPTION

Hereinafter, the present invention will be described in detail.

According to the invention, there is provided a photosensitive resin having excellent properties such as plasticity, adhesion and heat resistance, etc. without deteriorating other properties of a paint film, in which the photosensitive resin is useful for forming fine images on a paint film by using ultraviolet exposure and diluted aqueous alkaline solution, and a method for preparing the same.

According to an embodiment of the invention, there is provided an acid modified urethane phenoxy acrylate resin of Formula 1.

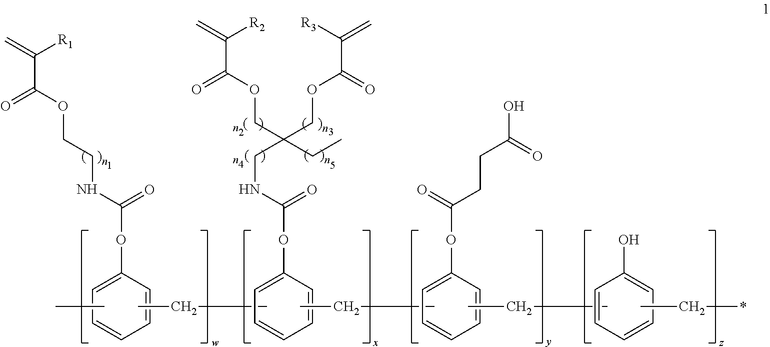

wherein, w, x is 0-0.7 mole, y is 0.1-0.5 mole, z is 0-0.7 mole, R₁, R₂, R₃ each is CH₃ or H, and n₁, n₂, n₃, n₄, n₅ each is an integer of 0-2.

A resin of the present invention is a photosensitive resin having an excellent balance between plasticity, adhesion and heat resistance, etc. and improved flexibility and toughness, etc., which have been poor in conventional resins, by introducing urethane structure in the resin. Such resins make up for disadvantages of conventional ones such as low expansion property and poor impact strength.

Acryloyloxyalkyl isocyanate is introduced to the resin of the present invention to contain a light curing group and improve physical properties, and a succinic anhydride is also introduced to a phenol-novolac resin to allow excellent developing property.

According to another embodiment of the invention, there is provided a method for preparing an acid modified urethane phenoxy acrylate resin of Formula 1, the method comprising (a) obtaining a compound of Formula 4 by reacting a phenol-novolac resin of Formula 2 with (metha)acryloyloxyalkyl isocyanate of Formula 3 or bis(metha)acryloyloxyalkyl isocyanate of Formula 3-1 (or both (metha)acryloyloxyalkyl isocyanate of Formula 3 and bis(metha)acryloyloxyalkyl isocyanate of Formula 3-1); and

(b) reacting the compound of Formula 4 with an acid anhydride,

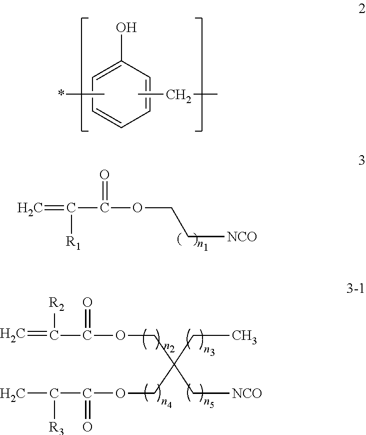

in Formula 3 and Formula 3-1, R₁, R₂, R₃ each is CH₃ or H, and n₁, n₂, n₃, n₄, n₅ each is an integer of 0-2.

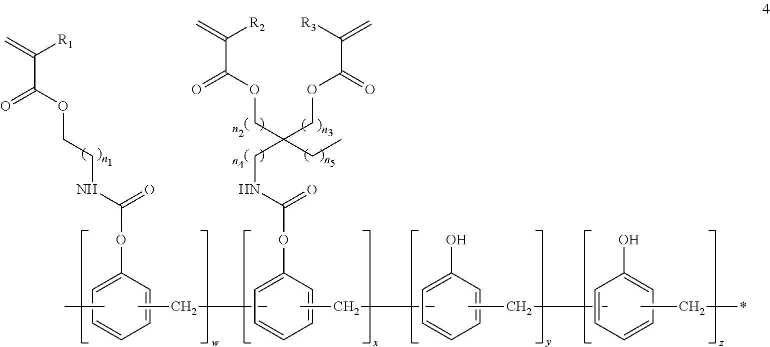

wherein, w, x is 0-0.7 mole, y+z is 0.3-0.8 mole.

According to an embodiment of the invention, the acid anhydride may be succinic anhydride of the following Formula 5.

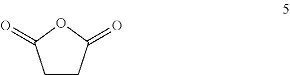

During a reaction of the present invention, a reaction catalyst such as tin catalyst, tertiary amine catalyst, phosphine catalyst may be used.

According to an embodiment of the invention, the step of (a) is performed by using a reaction catalyst chosen from di-n-butyltin dilaurate, tri-n-butyltin acetate, triethylamine, n-tributyltin trichloride, trimethyltin hydroxide, 1,8-diazabicyclo[5.4.0]undec-7-ene (DBU) and 1,5-diazabicyclo[4.3.0]non-5-ene (DBN). When a phenol-novolac resin of Formula 2 is reacted with at least one of acryloyloxyalkyl isocyanate chosen from the compounds of Formula 3 and Formula 3-1 by using the reaction catalyst at room temperature or 60-80° C., a compound of Formula 4 having urethane modified acrylic at side chain may be obtained. Here, acryloyloxyalkyl isocyanate may be used in 0-0.7 mole to 1 equivalent weight of the hydroxide group of each phenol-novolac resin. It is noted that the resin prepared within this ratio exhibits excellent properties.

According to an embodiment of the invention, the step (b) may be performed by using a reaction catalyst chosen from triphenylphospine, trimethylamine, triethylamine, benzyldimethylamine, dimethylaminomethyl phenol, tris(dimethylaminomethyl)phenol, methyltriethylammonium chloride, chromium octanoate and zirconium octanoate.

When the compound of Formula 4 obtained in the step (a) is reacted with an acid anhydride using the reaction catalyst in the step (b) at a temperature of 60-80° C., a resin of Formula 1 having acids at side chain is provided. Here, the acid anhydride is used in a 0.1-0.5 mole to 1 equivalent weight of the hydroxy group of the phenol-novolac resin. It is noted that the resin prepared within this ratio exhibits excellent developing property.

According to another aspect of the present invention, there is provided a photosensitive resin composition comprising an acid modified urethane phenoxy acrylate resin, a photopolymerization initiator and a diluent. The resin of the present invention is suitable for a photosensitive composition for printed circuit boards requiring fine images or a composition requiring negative type images.

### EXAMPLE

### Preparation of Acid Modified Urethane Phenoxy Acrylate Resin TD-2106 (phenol-novolac resin, Kangnam Chemical) 109 g and carbitolacetate 163.5 g were added into a reactor and the mixture was stirred at room temperature to be dissolved uniformly.

Hydroquinone (500 ppm to the total amount of agents used) and di-n-butyldilaurate 0.005 g were added and the result was stirred for 15 min. While keeping at room temperature, acryloyloxyethylisocyanate 70.5 g was added. The reaction was determined for completion by UV spectrometer when an absorption peak of an isocyanate functional group was disappeared at about 2260 cm⁻¹. A compound having a urethane modified acrylic group at side chain was obtained.

Triphenylphospine 1.31 g was added and dissolved and then succinic anhydride 50.1 g was added and stirred at 80° C. After checking that there is no absorption peak of an anhydride (C═O) functional group at about 1855 cm⁻¹ by UV spectrometer, the reaction was terminated and cooled to room temperature to provide an acid modified urethane phenoxy acrylate resin of the present invention (non-volatile material: 58%).

### Comparison Example 1

### Preparation of Acid Modified Epoxy Acrylate Resin

YD-011 (Bisphenol A type epoxy resin, Kukdo Chemicals, epoxy equivalent weight 476.6) 117.56 g and carbitolacetate 124 g were added to a reactor and the result was stirred while heating to be dissolved uniformly. Hydroquinone (500 ppm to the total amount of agents used) and triphenylphospine 1.1 g were added. While keeping the reaction mixture at 90-100, acrylic acid 18.86 g was added. The reaction was determined for completion by UV spectrometer when an epoxy absorption peak was disappeared at about 910 cm⁻¹. The reaction mixture was cooled to 80° C. and then tetrahydrophthalic acid anhydride 33.8 g was added and stirred at 80° C. After checking that there is no absorption peak of an anhydride (C═O) functional group at about 1855 cm⁻¹ by UV spectrometer, the reaction was terminated and cooled to room temperature (non-volatile material: 58%).

### Comparison Example 2

### Preparation of Acid Modified Novolac Epoxy Acrylate Resin

YDCN-500-100P (cresol novolac type epoxy resin, Kukdo Chemicals, epoxy equivalent weight 207.1) 114.96 g and carbitolacetate 170 g were added to a reactor and the result was stirred while heating to be dissolved uniformly. Hydroquinone (500 ppm to the total amount of agents used) and triphenylphospine 2.4 g were added. While keeping the reaction mixture at 90-100° C., acrylic acid 42.45 g was added. The reaction was determined for completion by UV spectrometer when an epoxy absorption peak was disappeared at about 910 cm⁻¹.

The reaction mixture was cooled to 80° C. and then tetrahydrophthalic acid anhydride 76 g was added and stirred at 80° C. After checking that there is no absorption peak of an anhydride (C═O) functional group at about 1855 cm⁻¹ by UV spectrometer, the reaction was terminated and cooled to room temperature (non-volatile material: 58%).

### Experimental Example 1

### Preparation of Resin Composition

Each resin obtained in Example and Comparison Examples was mixed in the composition as in Table 1 below and each resin composition was prepared by milling with a 3-roll mill to compare physical properties thereof.

TABLE 1

| | | Comparison | Comparison |
|---|---|---|---|
| | Example | Example | Example |
| | composition | composition 1 | composition 2 |
| Resin from Exam. | 150 | 0 | 0 |
| Resin from Com. | 0 | 150 | 0 |
| Exam 1. | | | |
| Resin from Com. | 0 | 0 | 150 |
| Exam 2. | | | |
| Photopolymerization | 10 | 10 | 10 |
| initiator | | | |
| Photosensitive | 5 | 5 | 5 |
| monomer | | | |
| Epoxy Resin | 30 | 30 | 30 |

photopolymerization initiator: Micure MS-7 (Miwon Commercial)
photosensitive monomer: DPHA (Nippon Kayaku)
epoxy resin: YX-4000 (Japan Epoxy Resin)

### Experimental Example 2

### Comparison of Physical Properties of Resin Compositions

Folding Endurance, Flexibility

The resin composition was coated on a kapton plate (thickness 25 μm), which was tap-water washed and dried, by a screen printing and dried with a hot-air dryer at 80° C. for 40 min. It was then cooled to room temperature and was exposed under the exposure dose of 1000 mJ/cm². Then it was cured with a hot-air dryer at 150° C. for 60 min. A sample of the result was tested for folding endurance and flexibility. Physical properties and measuring methods thereof were shown in the following Table 2.

TABLE 2

| | Testing method | Measuring method |
|---|---|---|
| Folding | Determining by folding 180° | ∘: no cracks on the cured |
| endurance | | film |
| | | Δ: Very little cracks on the |
| | | cured film |
| | | x: cracks on the cured film |
| Flexibility | | ∘: lower than 10 g of |
| | | maximum load |
| | | Δ: 10 g-30 g of maximum |
| | | load |
| | | x: 30 g or higher of |
| | | maximum load |

Acid Resistance, Alkali Resistance, Heat Resistance

A sample was prepared to determine physical properties of acid resistance, alkali resistance and heat resistance. The resin composition was coated on a printed circuit board, which was washed and dried, by a screen printing. It was then dried with a hot-air dryer at 80° C. for 40 min and cooled to room temperature. It was further exposed under an exposure dose of 1000 mJ/cm² and cured with a hot-air dryer at 15° C. for 60 min to provide a sample for testing acid resistance test, alkali resistance test and heat resistance test. Methods for testing measuring acid resistance, alkali resistance and heat resistance are shown in the following Table 3.

TABLE 3

| | Testing method | Measuring method |
|---|---|---|
| Acid resistance | After a sample board was immersed in | ∘: No change |
| | 10% sulfuric acid solution at room | Δ: Very little change |
| | temperature for 30 min, it was | x: Air bubble, swelling and |
| | determined for overall condition and | deterioration on the coating |
| | adhesion of the coating film. | film were detected. |
| Alkali | After a sample board was immersed in | ∘: No change |
| resistance | 10% sodium hydroxide solution at room | Δ: Very little change |
| | temperature for 30 min, it was | x: Air bubble, swelling and |
| | determined for overall condition and | deterioration on the coating |
| | adhesion of the coating film. | film were detected. |
| Heat resistance | After a sample board was dried with a | ∘: 100/100 (no peeling) |
| | hot-air dryer at 150° C. for 24 h, 10 × 10 | Δ: 99/100-70/100 (very |
| | (100 gradations) cross-cut adhesion test | little peeling) |
| | was carried out to determine the heat | x: 69/100 or lower |
| | resistance. | (significant peeling) |

Comparison on Physical Properties

The obtained result determined by the above testing and measuring methods is shown in Table 4.

TABLE 4

| | | Composition of | Composition of |
|---|---|---|---|
| | Composition of | Comparison | Comparison |
| Properties | Example | Example 1 | Example 2 |
| Folding endurance | ∘ | Δ | x |
| Flexibility | ∘ | Δ | x |
| Acid resistance | ∘ | ∘ | ∘ |
| Alkali resistance | ∘ | Δ | ∘ |
| Heat resistance | ∘ | Δ | ∘ |

As shown in Table 4, it is noted that the cured sample of the composition obtained by using the resin of the present invention has better properties and is thus more suitable for industrial uses than ones obtained by using a conventional photosensitive resin based on cresol novolac resin or Bisphenol epoxy resin.

While it has been described with reference to particular embodiments, it is to be appreciated that various changes and modifications may be made by those skilled in the art without departing from the spirit and scope of the embodiment herein, as defined by the appended claims and their equivalents. As such, many embodiments other than that set forth above can be found in the appended claims.

What is claimed is:

1. An acid modified urethane phenoxy acrylate resin represented by Formula 1, 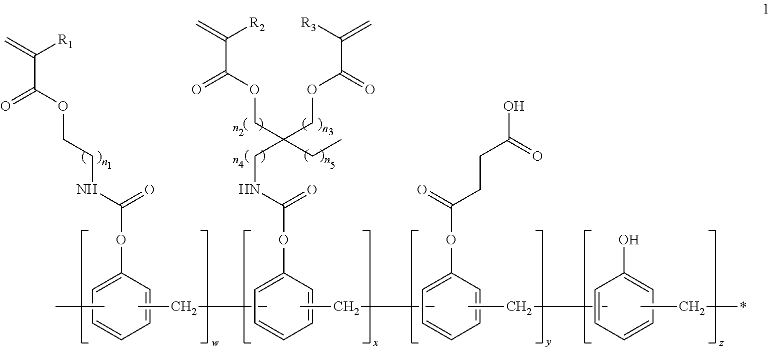
wherein, w, x is 0-0.7 mole, y is 0.1-0.5 mole, z is 0-0.7 mole, R₁, R₂, R₃ each is CH₃ or H, and n₁, n₂, n₃, n₄, n₅ each is an integer of 0-2.

2. A method for preparing an acid modified urethane phenoxy acrylate resin of Formula 1 comprising:
(a) obtaining a compound of Formula 4 by reacting phenol-novolac resins of Formula 2 with at least one (metha)acryloyloxyalkyl isocyanate selected from the group consisting of the compounds of Formula 3 and Formula 3-1; and
(b) reacting the compound of Formula 4 with an acid anhydride, 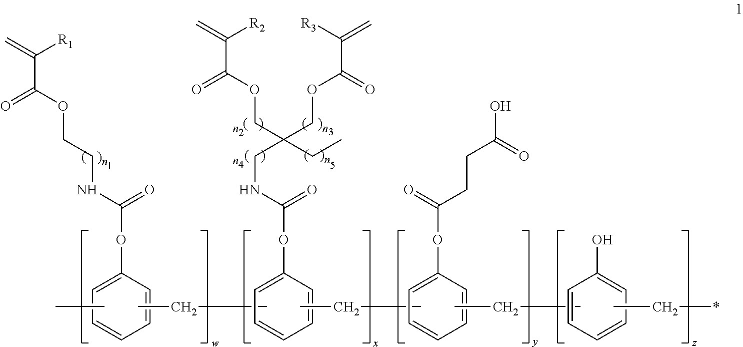
wherein, w, x is 0-0.7 mole, y is 0.1-0.5 mole, z is 0-0.7 mole,
R₁, R₂, R₃ each is CH₃ or H, and n₁, n₂, n₃, n₄, n₅ each is an integer of 0-2, 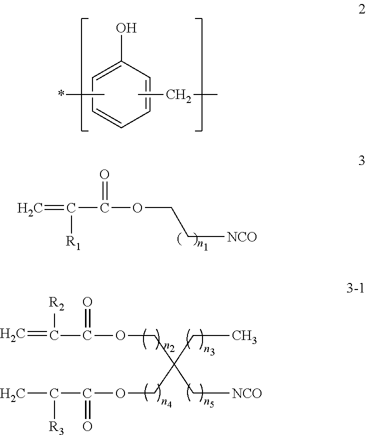
in Formula 3 and Formula 3-1, R₁, R₂, R₃ each is CH₃ or H, and n₁, n₂, n₃, n₄, n₅ each is an integer of 0-2, 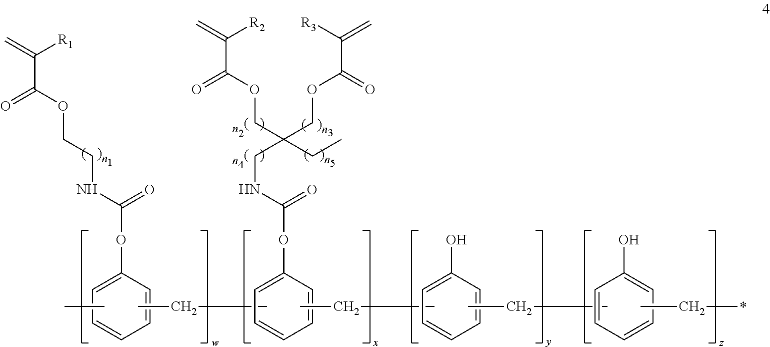
wherein, w, x is 0-0.7 mole, y+z is 0.3-0.8 mole.

3. The method of claim 2, wherein the acid anhydride is a succinic anhydride of Formula 5.

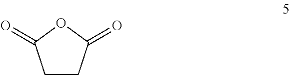

4. The method of claim 2, wherein the step (a) is performed by using a reaction catalyst selected from the group consisting of di-n-butyltin dilaurate, tri-n-butyltin acetate, triethylamine, n-tributyltin trichloride, trimethyltin hydroxide, 1,8-diazabicyclo[5.4.0]undec-7-ene (DBU) and 1,5-diazabicyclo[4.3.0]non-5-ene (DBN).

5. The method of claim 2, wherein the step (b) is performed by using a reaction catalyst selected from the group consisting of triphenylphospine, trimethylamine, triethylamine, benzyldimethylamine, dimethylaminomethyl phenol, tris(dimethylaminomethyl)phenol, methyltriethylammonium chloride, chromium octanoate and zirconium octanoate.

6. A photosensitive resin composition comprising the acid modified urethane phenoxy acrylate resin of claim 1, a photopolymerization initiator and a diluent.
